(19) United States
(12) Patent Application Publication
(10) Pub. No.: US 2005/0224271 A1
(43) Pub. Date: Oct. 13, 2005

(54) Vehicle traction improvement system

(75) Inventor: Steve Carr, High Point, NC (US)

Correspondence Address: WATTS HOFFMANN CO., L.P.A., P.O. Box 99839, Cleveland, OH, 44199-0830, US

(73) Assignee: Volvo Trucks North America, Inc.

(21) Appl. No.: 10/820,833

(22) Filed: Apr. 8, 2004

(51) Int. Cl. B60C 27/00; B60R 21/00

(52) U.S. Cl. 180/271

(57) ABSTRACT

A traction improvement system for an over-the-road vehicle includes a traction improvement module that sense vehicle hydroplaning and activates ultra-sound wave emitters to disrupt water surface tension in proximity to the tire when hydroplaning is sensed. The emitters direct ultra-sound waves onto the road surface as well as on the tire tread. An optional traction enhancing agent dispenser dispenses deicing solution or grit in proximity to the tire to further enhance traction.

### TECHNICAL FIELD

The invention relates generally to the field of vehicle traction control systems and in particular to a traction control system that utilizes the application of traction control measures not relating to brake control systems, to control vehicle traction.

### BACKGROUND OF THE INVENTION

Vehicle traction can become compromised in wet conditions due to a phenomenon known as hydroplaning. When a vehicle hydroplanes on a wet road surface, the tires lose contact with the road, making it difficult to steer or slow the vehicle. Several traction improvement systems have been developed that attempt to prevent or correct hydroplaning.

U.S. Pat. No. 5,100,175 to Swallow et al. concerns a traction enhancing kit that dispenses a liquid deicing agent in front of the drive wheels of a vehicle. The driver must actuate a switch on the dashboard to commence dispensing the deicing agent. The system requires periodic refill of the deicing agent and it is recommended that caps be placed over the deicing agent nozzles when the system is not in use. These maintenance drawbacks, in addition to the fact that manual actuation is required at the very time a driver needs both hands on the wheel detract from the efficacy of this system. Additional manually operated traction enhancement systems that blow air and/or heated liquid on the road surface immediately ahead of the tires are described in U.S. Pat. No. 4,063,606 to Makinson and U.S. Pat. No. 6,488,217 to Donastrong.

Other traction control systems are activated automatically when conditions are detected that predict that hydroplaning is occurring or likely to occur. For example, U.S. Pat. No. 5,350,035 to Bodier et al. describes an anti-hydroplaning system that, among several corrective measures, activates a mass jet of gas, liquid, or combination thereof in front of the vehicle wheels when hydroplaning is detected. Hydroplaning is detected by sensing vehicle vibration, the presence of splashing water by the tire, and degree of tire deflection. These factors are combined to determine when to activate the anti-hydroplaning measures. Because these factors only indirectly predict hydroplaning, the reliability with which hydroplaning is predicted may be compromised.

### SUMMARY OF THE INVENTION

According to one embodiment of the invention, a vehicle traction improvement system is provided that includes a traction improvement module. The traction improvement module receives signals indicative of vehicle operating parameters and determines if the vehicle is hydroplaning based on the received signals. The traction improvement module provides an output signal to activate at least one traction improvement measure. One of the traction improvement measures is an ultra-sound wave generator that supplies ultra-sound energy in proximity to a vehicle tire. A wave guide may direct ultra-sound waves onto the road surface in front of or onto some or all of the vehicle tires.

The traction improvement system may include a traction enhancing agent dispenser that is activated by the traction improvement system to dispense a traction enhancing agent such as a deicing solution or grit onto the road surface or the tire treads.

According to an exemplary embodiment, the traction improvement module receives signals from an accelerometer that indicates vehicle acceleration, from an axle speed sensor that indicates vehicle wheel speed, and from a brake module that indicates brake actuation status. The traction improvement module has stored in memory a correlation between the accelerometer data and axle speed sensor based on brake actuation status during normal vehicle operating conditions. When the signals from the accelerometer and axle speed sensor diverge from the correlation the traction improvement module activates the ultra-sound generator.

### BRIEF DESCRIPTION OF THE DRAWINGS

FIG. 1 is a functional block diagram of an ultrasonic traction improvement system constructed in accordance with an embodiment of the present invention;

FIG. 2 is a side view of the ultrasonic traction improvement system of FIG. 1 as installed on a vehicle,

FIG. 3 is a state chart illustrating states of operation of the ultrasonic traction improvement system of FIGS. 1 and 2;

FIG. 4 is a top plan view of an ultrasonic traction improvement system as installed on a truck in accordance with an embodiment of the present invention; and

FIG. 5 is a side plan view of an ultrasonic traction improvement system as installed on a truck in accordance with an embodiment of the present invention.

### DETAILED DESCRIPTION OF A PREFERRED EMBODIMENT

FIG. 1 is a functional block diagram providing an overview of the operation of a preferred embodiment of a traction improvement system 10. This embodiment will be described with reference to an over-the-road heavy-duty truck, however, it will be appreciated that the present invention can be advantageously employed on any vehicle. The traction improvement system 10 utilizes ultrasonic waves to disrupt the surface tension of water on the road surface to provide better traction when the tire engages the wet surface.

A traction improvement module 15 receives input signals from various vehicle sensors and produces outputs that selectively activate a variety of traction improvement measures based on the state of the input sensors. The traction improvement module 15 is suitably an environmentally hardened housing containing components necessary for control of the traction improvement measures such as programmable computers, memory circuits, software, and possibly control components such as electronic power circuitry, relays, valves and air lines. The traction improvement module 15 may be mounted in any location on the vehicle that will accommodate its specific dimensions, such as in an engine or cab compartment, and is connected to the vehicle sensors and traction improvement measures via electronic, pneumatic, hydraulic, or other necessary connections.

In the described embodiment the traction improvement module receives signals from an axle speed module 9, a brake module 8, and an accelerometer module 7. The axle speed module 9 monitors the rotation of each of the vehicle axles to determine the vehicle wheel speed and provides signals indicative of drive and non-drive (lead) wheels to the traction improvement module 15. The accelerometer module 7 generates a signal indicative of the vehicle's acceleration that is determined using data from a plurality of accelerometers mounted on the vehicle. When the brake module is associated with an ABS system, other data currently gathered for ABS system purposes to detect a skid condition can be provided to the traction improvement module 15. In a simplified version of the system, the traction improvement module can activate the ultrasound generator when the ABS system is activated. The brake module 8 monitors the state of the vehicle's braking system. In one embodiment, the brake module is associated with an ABS system and provides signals to the traction improvement module 15 that are indicative of whether or not the operator is currently actuating the brakes The traction improvement module 15 has stored in its memory instructions for controlling an ultra-sound generator module 20 and possibly a traction improvement compound injector control module 30.

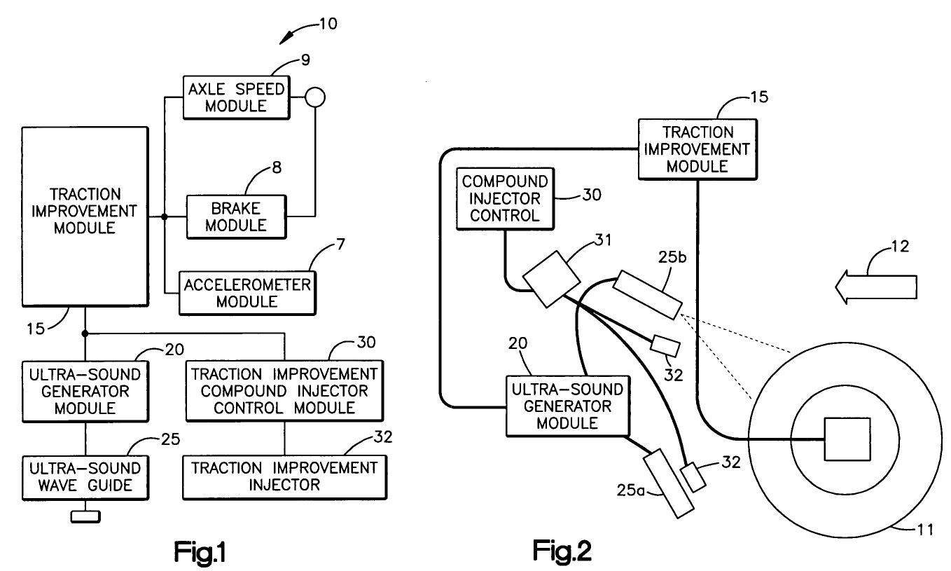

Referring to FIG. 2, in which the arrow 12 indicates the direction of vehicle travel, when actuated by the traction improvement module 15, the ultra-sound generator 20 generates ultra-sonic energy that is suitably directed through ultra-sound wave guides 25a, 25b to emit a stream of high intensity ultra-sound waves at the road surface and at the upper surface of each vehicle tire 11. The ultra-sound waves disrupt the surface tension of the water on the road surface and remove residual water from the tread grooves and tire surfaces. The sound frequency of the ultra-sound waves may be selected such that it heats the tire surface to further improve vehicle traction.

An optional traction improvement compound injector system is shown in FIG. 2. The traction improvement compound injector control module 30 is in communication with a reservoir 31 of a traction improving agent such as saline solution or a gritty material. When prompted by the traction improvement module, the traction improvement compound injector control module 30 actuates injectors 32 to cause the traction improving agent to flow from the reservoir 31, through the injectors 32, and onto the road and tire surfaces. In one embodiment the traction improvement compound may be imbedded in the tire tread by pressurized gas.

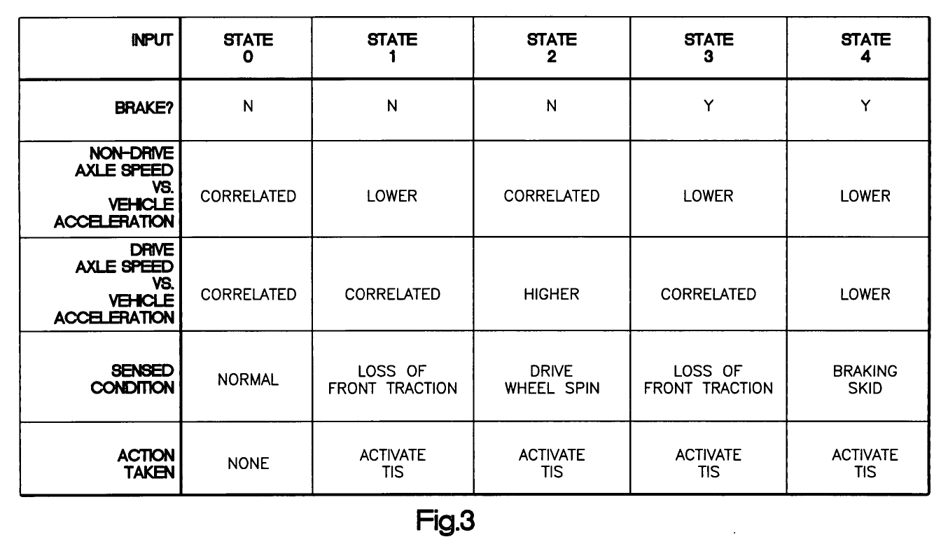

FIG. 3 is a portion of one possible control matrix that maps various states of the vehicle sensors as received by the traction improvement module to a corresponding vehicle operating condition and corrective action to be taken. Under normal operating conditions with the vehicle in forward motion, the traction improvement system is in State 0. The traction improvement module evaluates and compares signals from the non-drive and drive axle speed modules with respect to the accelerometer module which indicates vehicle acceleration, and the brake module, such as an ABS module, that indicates brake actuation. A baseline measurement of each of these signals and how they correlate with one another during normal vehicle operation is stored in the traction improvement module. The traction improvement module operates by detecting deviations in the received sensor signals from this baseline data. The baseline data includes data corresponding to expected vehicle behavior during braking. During braking the accelerometer module signal shows a decrease in vehicle motion that is proportional to the decrease in axle speed as determined from the axle speed module signal.

In the event of vehicle hydroplaning or loss of traction, the signals from one of the axle speed modules and the signal from the accelerometer module will begin to diverge. States 1-4 in FIG. 3 illustrate four examples of combinations of sensor signals that indicate a loss of traction and in which case the traction improvement module will activate the traction improvement system measures. In state 1, the non-drive tires of the vehicle lose contact with the road surface, a condition which may negatively impact steering control. The axle speed of the non-drive axle shows a marked decrease as compared to the vehicle acceleration, but with no brake engagement. The drive tires of the vehicle are still in contact with the road surface and show a normal or correlated axle speed with respect to the vehicle acceleration. When the non-drive axle speed signal and accelerometer signals diverge from normal correlation by a threshold amount, the traction improvement module activates the ultra-sound generator and possibly, if present, traction improvement compound injectors.

In State 2, the drive tires of the vehicle lose contact with the road surface and begin to spin free. While the accelerometer signal shows a less than expected rate of forward motion, the drive axle speed is higher than normal and no brake actuation is detected. When the drive axle speed signal and accelerometer signals diverge from normal correlation by a threshold amount, the traction improvement module activates the ultra-sound generator and possibly, if present, traction improvement compound injectors.

In State 3, the non-drive tires of the vehicle lose contact with the road surface during braking which may negatively impact steering control. The axle speed of the non-drive axle shows a marked decrease as compared to the vehicle acceleration, and the brake is engaged. The drive tires of the vehicle are still in contact with the road surface and show a normal axle speed with respect to the vehicle acceleration. When the non-drive axle speed signal and accelerometer signals diverge from normal correlation by a threshold amount, the traction improvement module activates the ultra-sound generator and possibly, if present, traction improvement compound injectors.

In State 4, the drive tires of the vehicle lose contact with the road surface and begin to skid during braking. While the accelerometer signal shows a higher than expected level of forward motion, the drive axle speed is lower than normal and brake actuation is detected. When the drive axle speed signal and accelerometer signals diverge from normal correlation by a threshold amount, the traction improvement module activates the ultra-sound generator and possibly, if present, traction improvement compound injectors.

In conclusion, if the traction improvement module cannot correlate the accelerometer signal with any one or both of the non-drive axle or drive axle speed, then the traction improvement module activates the ultrasound generator, and possibly, if present, any additional traction improvement measures such as injectors. The additional traction improvement measures can either be activated simultaneously with the ultrasound generator or when the difference between measured vehicle parameters and the correlated baseline reaches a different, higher threshold. Alternatively, the additional traction improvement measures could be activated if after a given period of time the ultrasound generator has not caused the measured vehicle parameters to more closely match the correlation.

In a simplified embodiment, only the accelerometer and brake signals are compared. If the brakes are applied and the accelerometer shows little or no change in the forward rate of acceleration of the vehicle the traction improvement system will activate the traction improvement measures. In another embodiment, the operator can manually engage the traction improvement measures in a continuous mode of operation.

The traction improvement measures are activated until the signals from the accelerometer and axle speed modules return to baseline correlation at which time the traction improvement measures are de-activated.

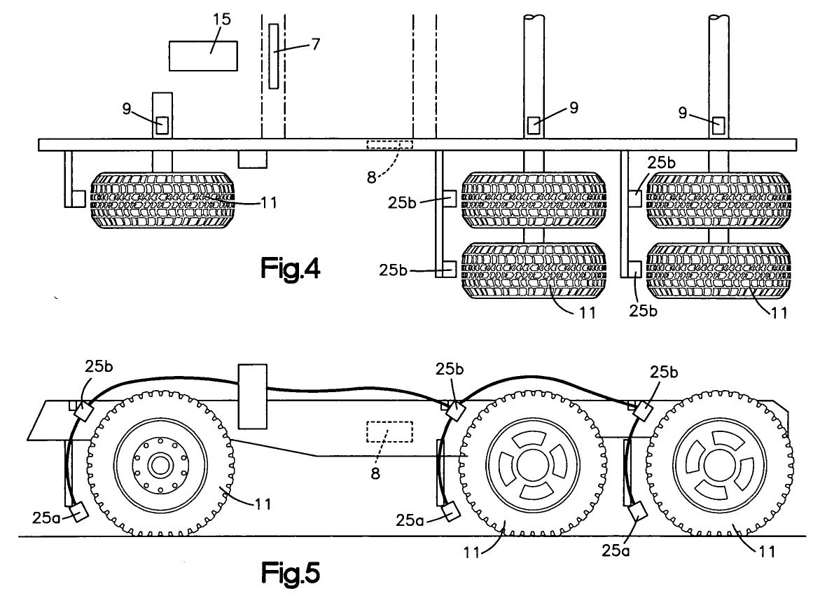

FIGS. 4 and 5 illustrate one possible mounting configuration for the components of the traction improvement system on the vehicle. The traction improvement module 15 is shown mounted in a location within the vehicle's cab, but could be mounted in the engine compartment, on a cross rail, or on a frame member. The accelerometer module 7 is shown mounted on a vehicle cross member while the brake module 8 is shown on the frame rail, however either component could be mounted on a cross rail, frame member, or in the cab. Axle speed modules 9 are mounted on or in proximity to each axle. As described in conjunction with FIG. 1, and shown functionally in FIG. 2, the connections between the various components, while not shown, can include current carrying wire, hydraulic or pneumatic lines, or other appropriate connections as will be apparent to one of skill in the art. The ultra-sound wave guides 25a, 25b are mounted on support structure so that they direct ultra-sound energy onto the road surface and tire tread, respectively.

Although the present invention has been described with a degree of particularity, it is the intent that the invention include all modifications and alterations from the disclosed design falling within the spirit or scope of the appended claims.

1. For an over-the-road vehicle, a system that improves vehicle traction in wet road conditions comprising:
a traction improvement module that receives signals indicative of vehicle operating parameters and determines if the vehicle is hydroplaning based on the received signals and wherein the traction improvement module provides an output signal to activate at least one traction improvement measure; and
an ultra-sound wave generator that is activated by the traction improvement module as a traction improvement measure that directs ultrasonic waves in proximity to a vehicle tire.

2. The system of claim 1 wherein the ultra-sound generator supplies ultra-sound energy to a wave guide that directs ultra-sound waves in proximity to a vehicle tire.

3. The system of claim 1 comprising an accelerometer that provides signals indicative of vehicle acceleration to the traction improvement module.

4. The system of claim 1 comprising an brake module that provides signals to the traction improvement module that indicate that brakes on the vehicle have been activated.

5. The system of claim 4 wherein the brake module is associated with an ABS system.

6. The system of claim 1 comprising an axle speed sensor that provides signals indicative of vehicle wheel rotational speed to the traction improvement module.

7. The system of claim 1 comprising a traction enhancing agent dispenser that is activated by the traction improvement system to dispense a traction enhancing agent in proximity to the vehicle tire.

8. The system of claim 7 wherein the traction enhancing agent is a deicing solution.

9. The system of claim 7 wherein the traction enhancing agent is rock salt.

10. The system of claim 7 wherein the traction enhancing agent is dispensed on the road surface immediately in front of the tire.

11. The system of claim 7 wherein the traction enhancing agent is dispensed onto the tire treads.

12. The system of claim 1 comprising a plurality of wave guides that direct ultra-sound waves in the proximity of each of the vehicle tires.

13. The system of claim 1 comprising a wave guide that directs ultra-sound waves onto the road surface immediately in front of the tire.

14. The system of claim 1 comprising a wave guide that directs ultra-sound waves onto the tire treads.

15. The system of claim 1 wherein the traction improvement module receives signals from an accelerometer that indicates vehicle acceleration, from an axle speed sensor that indicates vehicle wheel speed, and from a brake module that indicates brake actuation status and wherein the traction improvement module has stored in a memory a correlation between the accelerometer and axle speed sensor based on brake actuation status that represents normal vehicle operating conditions and wherein when the signals from the accelerometer and axle speed sensor diverge from the correlation the traction improvement module activates the ultra-sound generator.

16. A method for improving vehicle traction in wet road conditions comprising:
monitoring a plurality of vehicle operating parameters to obtain vehicle operating parameter values;
determining a baseline correlation between the vehicle operating parameter values during normal vehicle traction conditions;
during vehicle operation, monitoring the vehicle operating parameters and compiling an operating condition correlation;
comparing the operating condition correlation with the baseline correlation; and
activating an ultra-sound generator as a traction improvement measure that directs ultra-sound waves in proximity to a vehicle tire when the operating condition and baseline correlations deviate from one another by more than a threshold amount.

17. The method of claim 16 wherein the ultrasound generator supplies ultrasound energy to a wave guide.

18. The method of claim 16 wherein one of the plurality of vehicle operating parameters is measured by an accelerometer that provides signals indicative of vehicle acceleration.

19. The method of claim 16 wherein one of the plurality of vehicle operating parameters is measured by a brake module that provides signals that indicate that brakes on the vehicle have been activated.

20. The method of claim 16 wherein one of the plurality of vehicle operating parameters is measured by an axle speed sensor that provides signals indicative of vehicle wheel rotational speed.

21. The method of claim 16 comprising activating a traction enhancing agent dispenser that dispenses a traction enhancing agent in proximity to the vehicle tire.

22. The method of claim 16 wherein the wherein the one ore more vehicle operating parameter values are obtained from an accelerometer that indicate vehicle acceleration, from an axle speed sensor that indicates vehicle wheel speed, and from a brake module that indicates brake actuation status and wherein the baseline correlation correlates data from the accelerometer and axle speed sensor based on brake actuation status in normal vehicle operating conditions and wherein when the operating condition correlation diverges from the baseline correlation the traction improvement measures are activated.
